(19) United States
(12) Patent Application Publication
(10) Pub. No.: US 2007/0283114 A1
(43) Pub. Date: Dec. 6, 2007

(54) Method and system for dividing a hard disk drive into multiple host access spaces

(76) Inventor: Andy V. Lawrence, Alpine, UT (US)

Correspondence Address: TRASK BRITT, P.O. BOX 2550, SALT LAKE CITY, UT, 84110, US

(21) Appl. No.: 11/445,642

(22) Filed: Jun. 1, 2006

(51) Int. Cl. G06F 12/14

(52) U.S. Cl. 711/163

(57) ABSTRACT

Data storage device, system, and method for restricting host access to only one portion of a data storage device includes a storage device having a user space including a plurality of sectors and a plurality of host access spaces each including a corresponding plurality of portions of the plurality of sectors wherein only one of the plurality of host access spaces is accessible at any one time to a host device. A switch selects one of the host access spaces as the active host access space. The method restricts host access to only a portion of a data storage device by dividing a user space on the data storage device into a plurality of host access spaces, selecting one of the plurality of host access spaces as an active host access space, and restricting access by the host device to only the active host access space.

### BACKGROUND OF THE INVENTION

Field of the Invention: The present invention pertains generally to hard disk drives and, more specifically, to dividing the physical storage area of a hard disk drive into separate storage areas.

State of the Art: Music, video, text, and software are all examples of things that can be encoded digitally to form digital data. Such data is being generated, copied, and stored in mass quantities on a variety of data storage devices. One of the most common forms of these data storage devices is a hard disk drive, also simply known as a “hard drive.” As illustrated with reference to FIG. 1, a hard drive 100 provides a cheap and reliable means to store large amounts of digital data.

Hard drives have become ubiquitous in the computing industry. Hard drive use is also growing rapidly in the consumer electronics industry. Hard drives can be attached to a variety of host devices to provide data storage services. FIG. 1 illustrates a computing system including a host device 200 coupled through a connection to a hard drive 100. An exemplary host device may include a personal computer, a network server, or a portable computer such as a laptop. Host devices may further include consumer electronics such as a camera, a PDA, a mobile phone, a video camera, a stereo system, a portable music player, or any number of other electronic devices that need to store and retrieve large amounts of digital data.

Hard drives may be physically incorporated within a host device or may be physically separate. Therefore, based on the physical configuration of the host system, the hard drive may be categorized as either an internal hard drive or an external hard drive. An internal hard drive is often installed into the same physical enclosure as the host device. Separating the internal hard drive from the host device often requires turning the power off and mechanically disassociating the internal hard drive. An external hard drive on the other hand can be separated from the host device on a recurring basis without powering down or appreciable mechanical intervention. Using simple plug-in connections such as Universal Serial Bus (USB) or Firewire (IEEE 1394), external hard drives are easily moved from one host device to another.

While it is possible to create a hard drive of almost any size or dimension, the industry has built almost all drives around a few standard sizes. For example, a 3.5-inch diameter hard drive size is the most common in desktop computers while a 2.5-inch diameter hard drive size is typically common in laptop computers with small handheld devices typically including either a 1.8-inch or a 1.0-inch diameter hard drive. The smaller the drive size, the less the hard drive weighs and the less power the hard drive consumes, however, a smaller diameter hard drive also results in a reduced data storage capacity.

Generally, hard drives, regardless of size, are built using a similar basic architecture. FIG. 2 is a cross-sectional diagram of a typical hard drive. A typical hard drive includes one or more round disk platters 110A, 110B, 110C (collectively identified as platters 110 herein) mounted at the center to a single spindle 120. The platters 110 are mounted such that each disk platter is separated a small distance from other platters. A motor 130 is used to turn the spindle causing the attached disk platters to rotate together as a single unit at a uniform speed. Each disk platter 110 has two sides or surfaces 300A-1,2; 300B-1,2; 300C-1,2 (collectively identified as surface 300 herein). A separate mechanism called a read/write head 140A, 140B, 140C (collectively identified as read/write head 140 herein) is positioned to glide along each surface of disk platter 110. The read/write head 140 is used to either read or write data to the magnetic surface 300 of the disk platter 110. Each disk platter surface 300 has its own head 140A-1 through 140C-2. All the read/write heads 140 in a hard drive 100 are mounted on an actuator arm 150 so that all the heads within the disk drive 100 move in unison. The actuator arm 150 is able to position each head 140 from the outermost portion of a disk platter surface 300 to a position near its center.

FIG. 3 illustrates a plan view of a disk platter surface 300. Once a hard drive 100 has been assembled, the hard drive goes through a process called “low level formatting.” This formatting places special digital markers 320 on each area on disk platter surface 300 that is accessible by a read/write head 140. The markers 320 are laid down in concentric circles as the actuator arm positions the read/write head 140 at a fixed point and the disk platter 110 makes a full rotation with respect to the read/write head 140. Each circle on a platter surface 300 is called a track 310. Between each marker 320 on the track is space allotted for digital data to be stored. Each individual space is called a sector 330 and is made up of a fixed number of digital bytes. By way of example, a standardized sector size may be any quantity of bytes with 512 bytes being an example. Thousands of tracks 310 may be formed on each platter surface 300 in a hard drive. As expected, the quantity of tracks per platter increases with technological advances. A platter that holds hundreds of millions of data sectors is possible.

FIG. 4 illustrates an initial connection of a hard drive 100 to a host device 200. Host device 200 through internal circuitry and software controls hard drive 100 when initially connected. Conventionally, such an arrangement required the internal circuitry and software, (e.g., a hard disk controller 210), to have insight into the physical attributes and sector layouts of hard drive 100. When a computer needed to read a particular sector from the drive, it had to know the physical platter surface, the track number on that surface, and the physical sector number within the track in order to read the data. This made it very difficult for computers to be able to make use of a variety of hard drives. If a new hard drive was added to a computer, most likely a new hard disk controller would need to be installed as well.

To overcome this problem and as illustrated in FIG. 5, the hard drive industry began shipping each hard drive with a built-in IDE (Integrated Drive Electronics) circuit board 160. IDE circuit board 160 included controlling circuitry and software that “virtualized” the physical layout of the sectors on the disk drive. This means that a host device or computer could issue a command to read a data sector without knowing where that sector is located physically within the drive. Each data sector within the drive is assigned by the disk drive a unique number called a Logical Block Address (LBA).

By virtualizing the sector layouts of the drive, the IDE board (160) could now also be used to improve the speed and reliability of the hard drive. Techniques such as reading extra sectors into a track buffer 170 and reordering sector numbers within the drive could now be implemented without requiring a new disk controller in every host device. Sectors that were bad due to imperfections on the platter surface could now be remapped to a “hot fix” area of the disk thus making the flaws invisible to the host device. Using these techniques, all the usable data sectors within the disk drive could be presented to the host device as a single contiguous user space 400 as illustrated with respect to FIG. 6.

A host device communicates with the disk drive using a set of standard commands. Two separate command sets are known and a hard drive typically confirms to either an Advanced Technology Attachment (ATA) command set or a Small Computer System Interface (SCSI) command set. Each command set contains commands for reading and writing sectors of data. A hard drive and the hard drive's associated command set make no distinction between the various types of data stored in each sector. It is up to the host device to keep track of which sectors contain system or user data and in what order they belong. It typically does this by using one or more file systems.

FIG. 7 illustrates division of a user space within a disk drive. A user space 400 within the disk drive can be divided into logical areas called disk partitions 410. Once a disk partition 410 is formatted with a particular file system 420, the disk partition 410 may be called a volume 430. The file system 420 controls all the sectors located within the volume as illustrated with respect to FIG. 8. The volume 430 includes stored files 440 and may provide a form of hierarchy or other order using folders or directories. The file system 420 (FIG. 7) monitors which sectors within the volume 430 are unallocated and which sectors have been assigned to individual files and any corresponding order.

By organizing data in this fashion, the host device is able to create, copy, read, and delete a large number of files within the logical boundaries presented by the hard drive. Since each file can be changed at any time as well as new files being added, the total set of data stored on a hard drive changes over time. These changes to the data set can be intentional such as when a user saves a new document or copies some pictures from a camera, or the changes can be unintentional such as when a user accidentally deletes a folder or has a computer virus attack the system.

The hard drive is also often used to boot the host device. This means the host device loads the host device's operating system software 450 from the hard drive. The operating system 450 consists of a set of files located within one of the file system volumes 430, therefore, it is possible to install more than one operating system to a single hard drive. The one or more operating systems may include completely different operating systems or may be different versions of the same operating system. Furthermore, each operating system may be installed in a separate file system volume as illustrated in FIG. 9 or each of the one or more operating systems may share the same file system volume as illustrated with respect to FIG. 10. However, it is often difficult for different versions of the same operating system to share a single file system volume since the different versions often have the same names for critical system files and folders. When a single disk drive contains more than one operating system, the hard drive may be referred to as a multi-boot drive. In such a case, the host device typically first loads and displays a special menu that displays each of the operating systems in order to let the user choose which operating system is to be loaded.

In another implementation, a single operating system may be used and accessed by several users. In order to help keep the data for each user private, the operating system allows an administrator to set up individual user accounts within the system. The system tries to separate private user files into special folders that become visible to the user once they log into the system.

It is important to note that the protections that exist for separating the files of multiple operating systems or the files of individual users within a single operating system are generally not very secure. Since the host device 200 has access to the entire user space 400 on the drive, software running on the host device can read or write any sector 330. Such relatively unrestricted access allows a virus or malicious user to read, alter, or destroy not only files for the current user and operating system, but also files for other operating systems or users that may have been set up on the hard drive.

Since hard drives are mechanical devices, they are subject to failure. Although hard drives have become more reliable, there are still a number of failure modes. The motor that turns the spindle can burn out, the attached IDE circuit board can short out, a read/write head can accidentally scratch the surface of a disk platter, or the actuator arm can break. All these instances generally result in a catastrophic failure of the hard disk drive. For this reason it is important for the data stored on the hard drive to be periodically copied to another hard drive or other storage medium. This procedure is called “backing up your data” or a backup operation.

It is important to back up data regularly since it can become corrupted at any time. Mechanical failure can destroy data, but the most common form of corruption is the unintended changes to the file system caused by software or user error or by malicious software like a computer virus. If the volumes on a hard drive are backed up regularly and data corruption occurs, the data can be restored to its former state.

As illustrated in FIG. 11, one of the most common methods of performing a backup operation is to create a disk image 500 using backup software 510. An image can contain the entire data set of the hard drive or a subset of the data. The subset image typically contains just the changes made since the last backup operation and is thus often called an incremental image. An image is created by either copying the files from a hard disk volume, or by copying the used blocks or clusters within the volume. In either case, a volume can be restored to its former state by overwriting the volume with the contents of the image.

Images are typically stored on another hard drive or on removable media such as disks (CD or DVD) or tape. If the data set on a hard drive becomes corrupted it is necessary to have access to the image media in order to restore the image. Computer manufacturers conventionally have included a factory image on a CD or DVD disk with new computers. Such a factory image allows the user to restore the machine to its original factory settings in the event of data corruption.

Computer manufacturers faced a problem where the CD or DVD disk containing the factory image became either lost or damaged. The user could not restore the hard drive to its factory settings and taxed the manufacture's customer support line for resolution. One solution to this problem was to store the factory image within the user space of the hard drive. This solved some of the problems but presented another. Since the factory image was stored on the hard drive, it was subject to corruption just like any other data stored on the drive. Unintentional actions by the user or malicious actions by a virus program could corrupt the image.

To solve this problem, the industry added a change to the ATA specification. In version 5 of the official ATA document a “SET MAX” command was added. As illustrated in FIG. 12, this command allowed special software running on the host device to reserve part of the disk for disk images and other similar data. Access to this reserved area, called the Host Protected Area, would be restricted and thus protected from the normal means of disk data corruption. This solution did not save the user from data corruption due to mechanical failure, but did allow the user to restore factory settings in the vast majority of cases.

The Host Protected Area (HPA) generally is located at the end of the logical disk space and is typically a small portion of the total disk space. Because it is a logical area, it could be physically located anywhere on the disk platter surfaces. Because of its small size in relation to the total disk area, it is typically limited to an image of the data set created by the computer manufacturer. If the user wishes to preserve the data sets resulting from constant use of the host device, regular images should be made. Otherwise, all data created or changed by the user after the initial factory settings could be lost.

When an image of a hard drive is created without the use of other storage media, a data set is read from the hard drive by the host device and written to an image located on another area of the same hard drive. Likewise, if that same image is later restored, all the data from the image must be read by the host device and written back to the hard drive. Depending on the amount of data being backed up or restored, this can be a very time consuming operation and require significant processing resources from the host device.

The traditional hard drive device with spinning disk platters has seen competition in recent years from static data storage devices such as flash drives. These flash drives contain static memory chips that enable them to store digital data without moving parts. While the storage capacity of these drives has been much less than the capacity of most hard drives, their capacity has grown to a point where they can compete with the smallest form factor hard drives. Flash drives are configured to emulate traditional hard drives with respect to their connection to a host device. They use the same ATA interface and they present their storage space to the host device as a set of sectors just as hard drives do. In general, the host device is unable to tell if the attached data storage device uses spinning platters or solid state memory chips to store the data.

As various forms of media become prevalent and as multiple users may access shared hardware, there is a need to divide a single hard drive into separate access spaces that are not entirely visible to the host device at a single time. There is also a need to provide an efficient mechanism for generating backup images of data on a hard drive.

### BRIEF SUMMARY OF THE INVENTION

A hard drive, system, and method for restricting access by a host device to only one portion of a data storage device or hard drive is disclosed. In one embodiment of the present invention, a data storage device or hard drive for coupling to a host device includes a user space including a plurality of sectors for storing data therein. The data storage device or hard drive further includes a plurality of host access spaces each including a corresponding plurality of portions of the plurality of sectors wherein only one of the plurality of host access spaces is accessible at any one time to the host device. Furthermore, the data storage device or hard drive includes a switch for selecting each one of the plurality of host access spaces.

In another embodiment of the present invention, a system including a host device and a data storage device or hard drive is provided. The data storage device or hard drive includes a user space for storing data therein and a plurality of host access spaces each including a corresponding plurality of portions of the plurality of sectors wherein only one of the plurality of host access spaces is accessible at any one time to the host device and a switch for selecting each one of the plurality of host access spaces.

In a further embodiment of the present invention, a method for restricting access by a host device to only a portion of a data storage device or hard drive is provided. The method includes dividing a user space including a plurality of sectors for storing data therein on the data storage device or hard drive into a plurality of host access spaces and selecting one of the plurality of host access spaces as an active host access space. The method further includes restricting access by the host device to only the active host access space.

### BRIEF DESCRIPTION OF THE SEVERAL VIEWS OF THE DRAWINGS

In the drawings, which illustrate what is currently considered to be the best mode for carrying out the invention:

FIG. 1 illustrates a system including a host device supporting a hard drive;

FIG. 2 illustrates a functional cross-sectional diagram of a hard drive;

FIG. 3 is a plan view of a surface of a disk platter;

FIG. 4 is a block diagram of a system including a disk controller;

FIG. 5 is a block diagram of a system including an IDE hard drive;

FIG. 6 illustrates sector division of user space in a hard drive;

FIG. 7 illustrates volume division of user space in a hard drive;

FIG. 8 illustrates an arrangement of files in a volume in a hard drive;

FIG. 9 illustrates multiple operating systems located within respective volumes in a hard drive;

FIG. 10 illustrates multiple operating systems located within a single volume in a hard drive;

FIG. 11 illustrates a flow diagram illustrating imaging of data in a user space of a hard drive;

FIG. 12 illustrates a division in a hard drive for forming user space and a host protected area;

FIG. 13 is a block diagram of a system including a hard drive configured to support a plurality of Host Access Spaces (HASs), in accordance with one or more embodiments of the present invention;

FIG. 14 illustrates a division of a hard drive into separate host access spaces, in accordance with one or more embodiments of the present invention;

FIG. 15 illustrates a functional cross-sectional diagram of a hard drive separated into one or more backup images;

FIG. 16 illustrates a series of backups which may be implemented as a result of the division of Host Access Spaces (HASs), in accordance with another embodiment of the present invention; and

FIG. 17 illustrates dividing user space into data type specific Host Access Spaces (HASs), in accordance with another embodiment of the present invention.

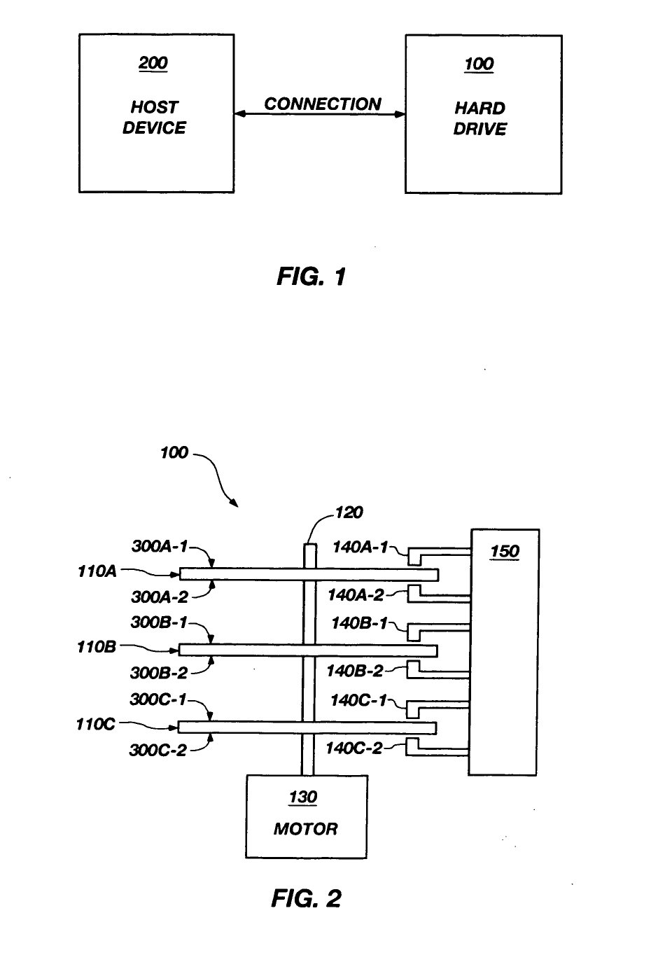

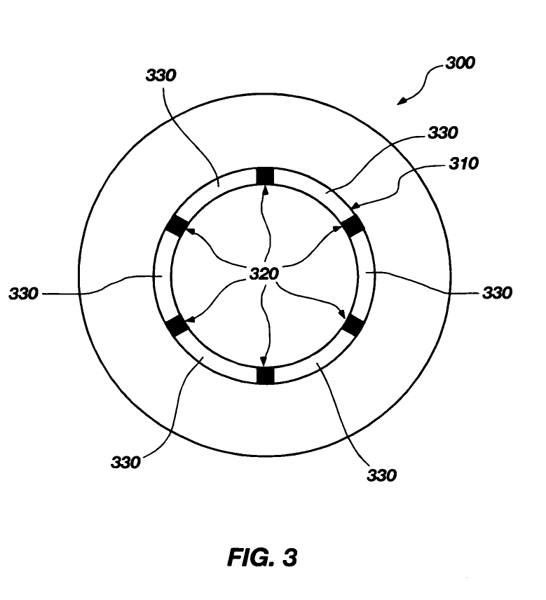

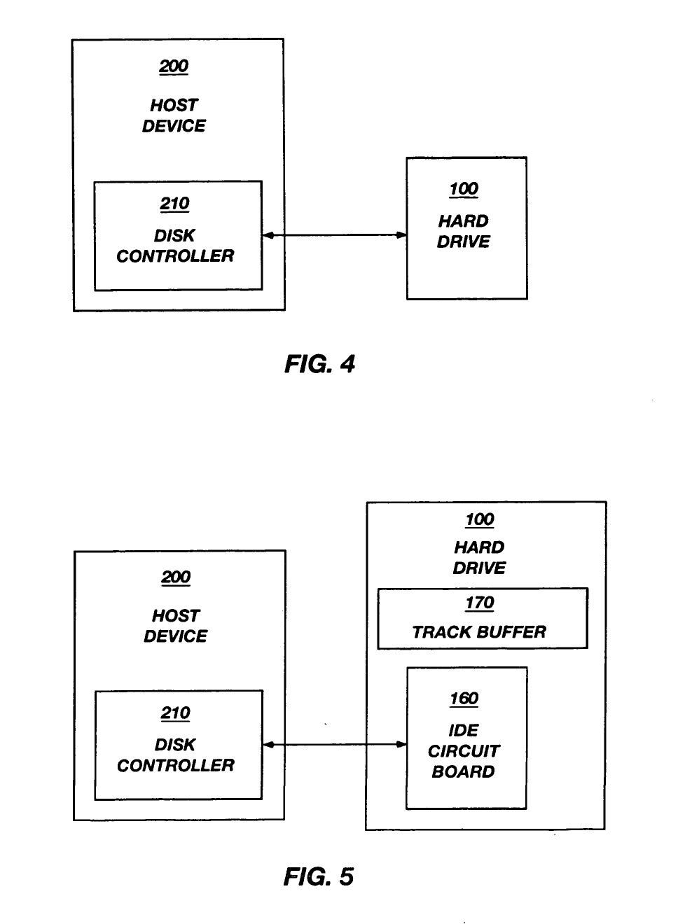

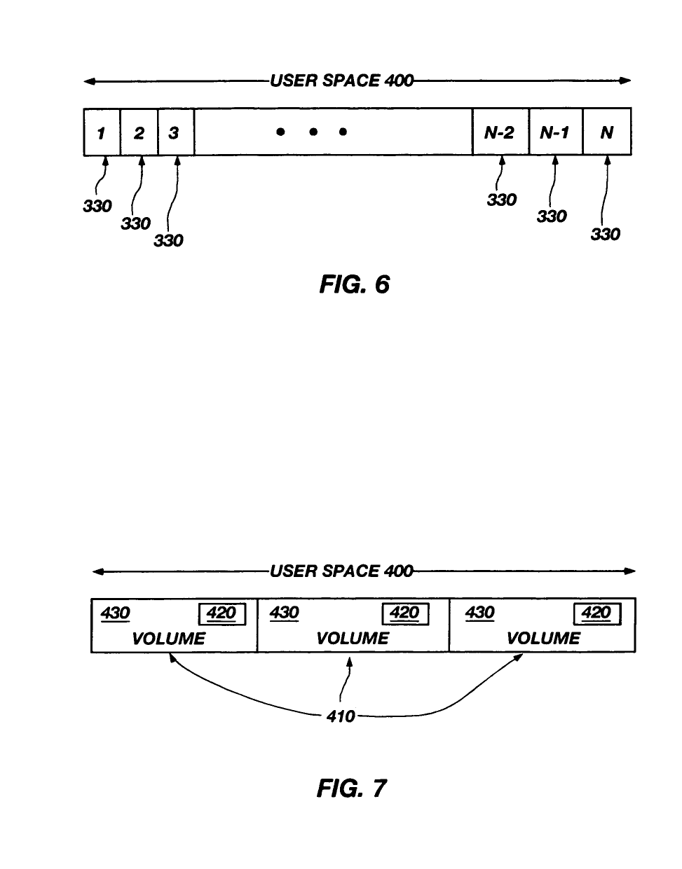

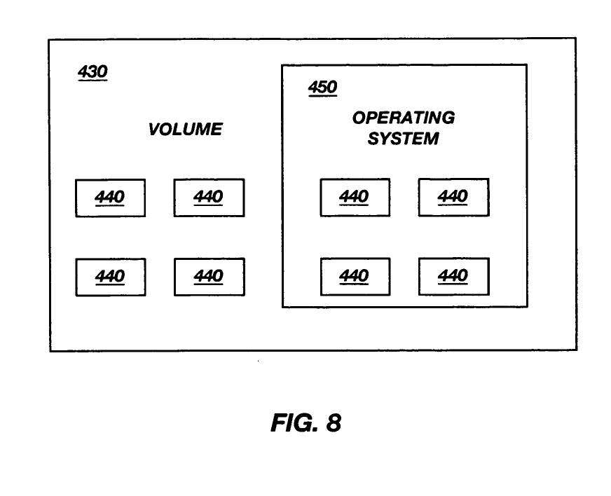

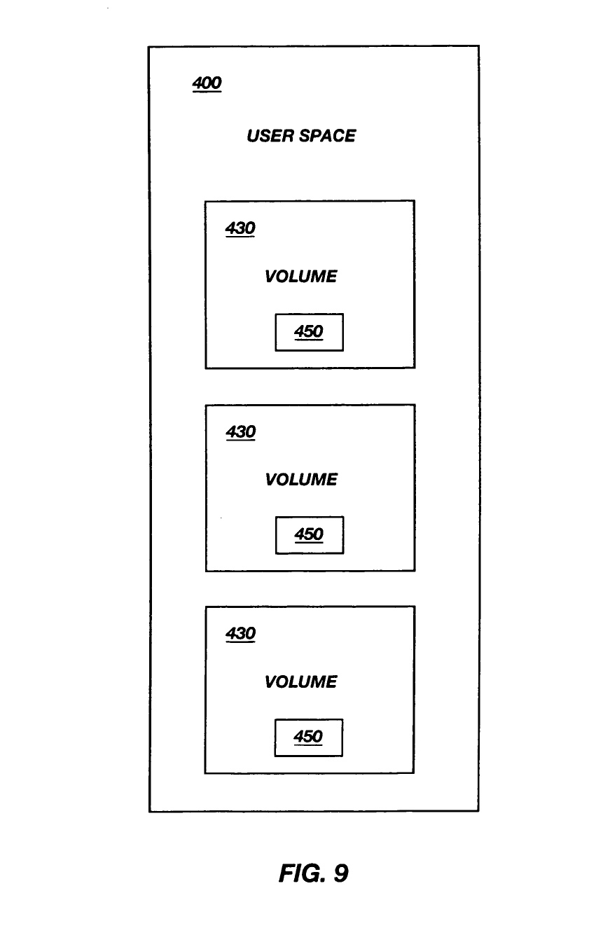

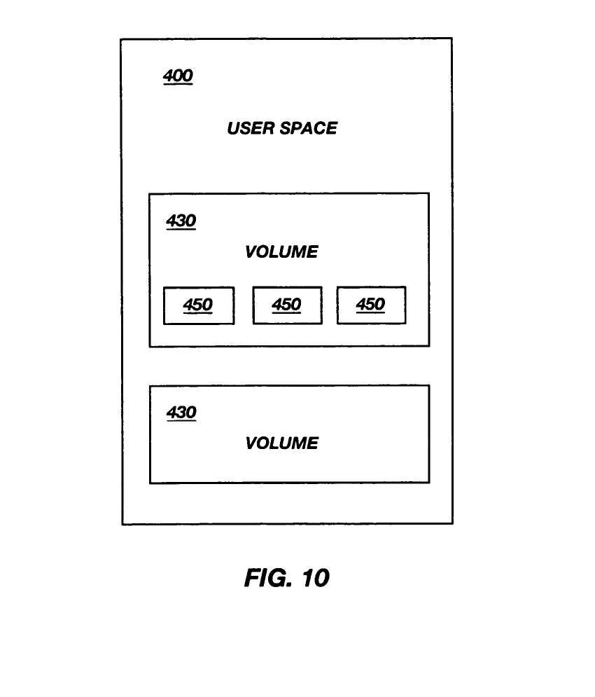

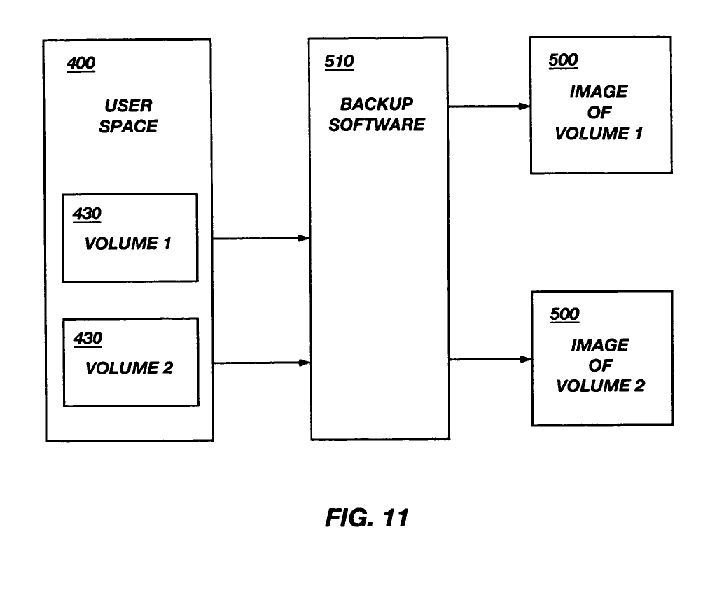

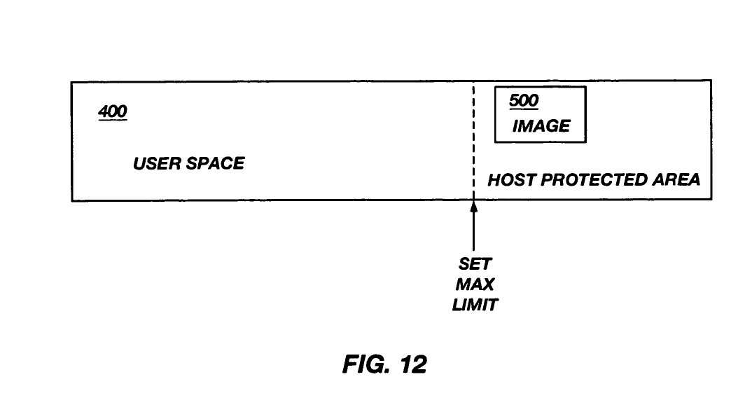

### DETAILED DESCRIPTION OF THE INVENTION

As used herein, the term “data storage device” includes hard drives, as well as other data storage means including semiconductor non-volatile storage such as “Flash” memory devices, magnetic storage means as well as optical storage means that function as a server of sectors.

In one or more embodiments of the present invention, a method for dividing a single data storage device into two or more separate Host Access Spaces (HAS), only one of which can be visible to an attached host device at any given time, is described. During a reset operation, a different Host Access Space (HAS) could be made active or visible thus giving the appearance to the host device that the data storage device or hard drive unit had been replaced with an entirely different data storage device or hard drive. The non-active Host Access Spaces (HASs) are completely protected from any data read or data write operations initiated by the host device. If the Host Access Spaces (HASs) are divided along physical disk platter boundaries, each non-active Host Access Space (HAS) can be used to store a complete backup of all data in the active Host Access Space (HAS). Backup operations can be performed completely within the data storage device or hard drive unit while the data storage device or hard drive unit continues to service data read and data write requests from the host device. A restore operation can be performed as quickly as the data storage device or hard drive can be reset.

The present invention may be embodied in a method wherein a single physical data storage device or hard drive can divide its total storage space into two or more distinct logical storage spaces for the purpose of separating those spaces from access by a host device. Each of these logical storage spaces is called a Host Access Space (HAS). A host device may only be given access to a single Host Access Space at one time. This will effectively “hide” the other Host Access Spaces from the host device's view. These hidden spaces are protected from any software running on the host device including low level division and formatting software.

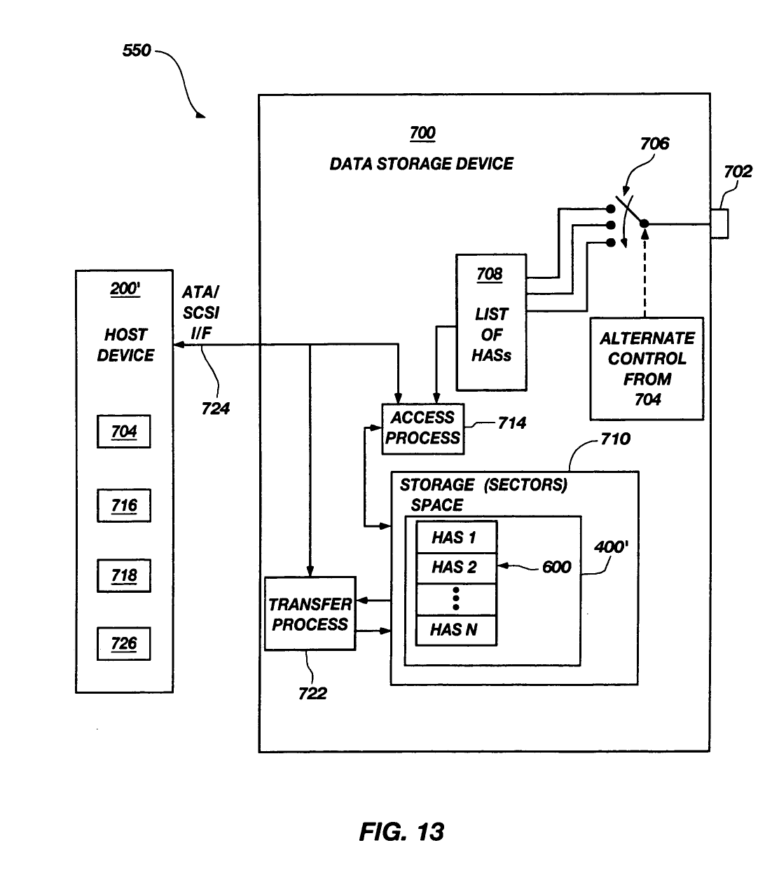

FIG. 13 is a block diagram of a system 550 including a data storage device or hard drive configured to support a plurality of Host Access Spaces (HASs) and a host device, in accordance with one or more embodiments of the present invention. By means of a switch 702 on the data storage device or hard drive 700, or by a special software program 704 running on the host device 200′, the user selects, for example from a list 708 through a switch 706 which one of a plurality of Host Access Spaces (HASs) 600 within storage space 710 will be visible as enforced by an access process 714 to the host device 200′ the next time the data storage device or hard drive 700 is reset.

Various reset options are contemplated. By way of example and not limitation, the reset operation may be accomplished by disconnecting and reconnecting the disk drive 700 from the host device 200′, turning the host device 200′ off and then back on, or by rebooting or otherwise resetting the host device 200′, and may further include other authorization options such as requiring a user to enter a passkey or biometric measurement to complete the selection of the next visible Host Access Space (HAS) 600 automatically. If the passkey or biometric measurement matches a Host Access Space (HAS) designation, the data storage device or hard drive 700 would automatically select that specific Host Access Space (HAS) 600 as being visible to the host device 200′. Likewise, a Host Access Space (HAS) 600 could be matched to an identifier sent by the host device 200′ when the data storage device or hard drive is attached or reset. Accordingly, to the host device 200′, the reset or reconfiguration process appears as if the data storage device or hard drive 700 had been physically replaced by a completely different data storage device or hard drive 700.

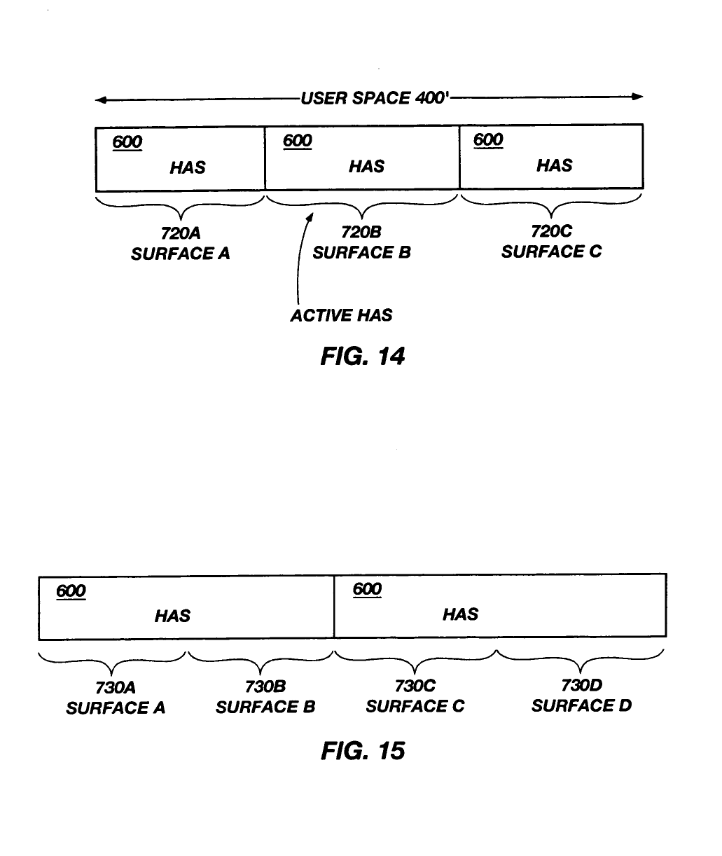

FIG. 14 illustrates a user space 400′ of the storage space 710 (FIG. 13) for dividing into Host Access Spaces (HASs) 600. As illustrated, one of the Host Access Spaces (HASs) 600 is designated as the active Host Access Space 600 in response to one of the aforementioned switching or designation mechanisms described with respect to FIG. 13. According to the various embodiments of the present invention, a method for creating a modified version of a hard disk drive (or other mass-produced digital data storage device similar in functionality to a hard disk drive) such that the modified version is capable of acting like several distinct data storage device or hard drive units is provided. For example: a single 500 GB data storage device or hard drive could be configured to behave like a box containing two separate 250 GB data storage devices or hard drives. That same drive could be configured to behave like five separate 100 GB data storage devices or hard drives, or ten separate 50 GB data storage devices or hard drives, or a 200 GB and a 300 GB data storage device or hard drive, or any number of other combinations adding up to 500 GB. Each of the simulated, smaller drives would be a logical drive called a Host Access Space (600) as illustrated with respect to FIG. 14.

When the configured data storage device or hard drive 700 (FIG. 13) is connected to a host device 200′ (FIG. 13) such as a computer, the host device 200′ interacts with just one of the Host Access Spaces (HASs) 600 at a time. To host device 200′, the data storage device or hard drive 700 does not appear to be, for example, one 500 GB data storage device or hard drive, but instead appears to be a single 100 GB drive, or a 50 GB drive, or whatever size the active Host Access Space (HAS) 600 has been segmented. The Host Access Space (HAS) 600 would appear to the host device 200′ as a typical regular hard disk drive 700 and could be divided and formatted with several file system volumes each of which may include separate individual files. For example, the activated Host Access Space (HAS) 600 is configured to be capable of being backed-up, having a backup image restored, or being erased by a formatting tool or other disk utility. Regardless of the selected data storage device or hard drive process, only the active Host Access Space (HAS) 600 is affected by the operation requested by the host device 200′ while each of the inactive Host Access Spaces (HASs) 600 is protected from being addressed or accessed by the host device.

In order for host device 200′ to access another Host Access Space (HAS) 600, the other Host Access Space (HAS) 600 would need to be set as the next active Host Access Space (HAS) 600 and then the data storage device or hard drive 700 would need to be reset. Such a reconfiguration appears to the host device 200′ as if, for example, the user had unplugged the current data storage device or hard drive and replaced it with a completely different data storage device or hard drive. To set another Host Access Space (HAS) as active, the user could select the next Host Access Space (HAS) from, for example, a menu in special software program 704 running on the host device 200′, or physically select it by means of switch 702, such as a mechanical device, knob or keypad configured as part of data storage device or hard drive 700. Additionally, the reset operation could be accomplished by power-cycling the host device 200′ or by disconnecting and then reconnecting the data storage device or hard drive 700 with host device 200′.

In another embodiment, a specific Host Access Space (HAS) may also be automatically set as the active Host Access Space (HAS) during initialization of the data storage device or hard drive 700 by the host device 200′. For example, such a setting of a specific Host Access Space (HAS) may be accomplished if the host device 200′ sent an identifier 716 to the data storage device or hard drive 700 that matched one of the pre-configured Host Access Spaces (HASs) 600. In yet another embodiment, a passkey or biometric measurement 718 could also be passed to the data storage device or hard drive 700 during initialization that matched a particular Host Access Space (HAS) 600.

By way of example and not limitation, a data storage device or hard drive 700 could be attached to a host device 200′, such as a computer, shared by several different users. An administrator could configure the data storage device or hard drive 700 to have a corresponding number of different Host Access Spaces (HASs) 600 corresponding to each user. When a specific user turned on the host device 200′ (e.g., computer), the user could enter a passkey or a biometric measurement (e.g., fingerprint) causing the host device 200′ to initialize to a corresponding Host Access Space 600 and allow access to the data in the user's specific Host Access Space (HAS) and prevent access to Host Access Spaces (HASs) that belong to others. In fact, the various embodiments of the present invention preclude the host device 200′ from recognizing the existence of other Host Access Spaces (HASs) 600.

The plurality of Host Access Spaces (HASs) 600 may be divided within storage space 710 according to various boundaries. FIG. 14 illustrates one embodiment of the present invention wherein the user space 400′ of storage space 710 (FIG. 13) is divided into Host Access Spaces (HASs) 600 along physical platter surface boundaries. Each Host Access Space (HAS) 600 consists of one or more complete physical platter surfaces, three representative ones of which are designated as surfaces 720A-C, with each of the Host Access Spaces (HASs) 600 within the data storage device or hard drive 700 being generally configured as equal in storage capacity.

In an embodiment of the present invention as further illustrated with respect to FIG. 13 wherein each of the Host Access Spaces (HASs) 600 is divided along surface boundaries, data transfer applications, such as data backup operations, may be significantly more efficiently implemented by transferring data between Host Access Spaces (HASs) under hard disk control by transfer process 722 on, for example, a track-by-track basis without requiring the data to uploaded over host interface 724 to the host device 200′ from a first Host Access Space (HAS) and then downloaded over host interface 724 from the host device 200′ to a second or backup Host Access Space (HAS). Such a configuration enables the data storage device or hard drive 700 to transfer data between Host Access Spaces without help from the host device and without needing to know anything about how the storage space has been utilized by a file system or other “upper level” software that may manage the space. In such an embodiment, at least some of the Host Access Spaces (HASs) would contain data sets that are related, meaning they are the same data set at different time intervals. Additionally, the disk drive 700 could monitor which physical tracks on each platter surface a host device 200′ has modified also using the transfer control process.

A synchronize or backup process 726 running on the host device would be used to send commands to the transfer process 722 on data storage device or hard drive 700 to synchronize the data between two or more Host Access Spaces (HASs). Transferring data from one Host Access Space (HAS) to another without requiring host device intervention allows the data storage device or hard drive to perform instant “snapshot” backup operations and near instantaneous restore operations. Furthermore, the data storage device or hard drive 700 may also continue handling read and write requests from the host device while performing backup and restore operations in the background.

In another embodiment of the present invention as illustrated with respect of FIG. 15, Host Access Spaces (HASs) 600 may be divided to include multiple surfaces of the data storage device or hard drive. Each Host Access Space (HAS) 600 consists of more than one complete physical platter surface, four representative ones of which are designated as surfaces 730A-D, with each of the Host Access Spaces (HASs) 600 within the data storage device or hard drive 700 being generally configured as equal in storage capacity. Accordingly, a data storage device or hard drive 700 could be configured as an instant backup and restore device. When the data storage device or hard drive 700 is in such a mode, all Host Access Spaces (HASs) are the same size and each consists of one or more complete disk platter surfaces. Specifically, a current or active Host Access Space (HAS) may contain the current working data set while another Host Access Space (HAS) contains snapshot images of the active Host Access Space (HAS).

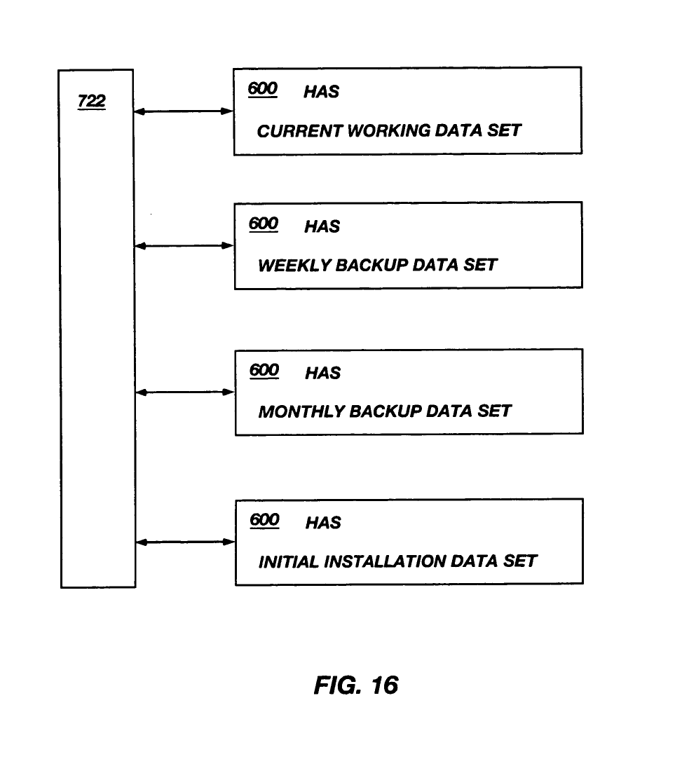

FIG. 16 illustrates a series of backups which may be implemented as a result of the division of Host Access Spaces (HASs), in accordance with another embodiment of the present invention. An instant backup operation may be initiated by a user or as previously configured to transfer any platter surface tracks in the active Host Access Space (HAS) 600 that have been modified since the last backup to one or more of the other Host Access Spaces (HASs) 600. In addition to a backup operation that results from the division of the user space into a plurality of Host Access Spaces (HASs), a restore option is also contemplated which overwrites any modified tracks in the active Host Access Space (HAS) 600 with data from one of the backups stored in the other Host Access Spaces (HASs) 600.

In either case, the data transfers happen within the data storage device or hard drive 700. The data does not need to be sent to or through the host device 200′. Furthermore, the active Host Access Space (HAS) 600 may continue to service data requests from the host device 200′ while the backup or restore data transfers are being done in the background. Additionally, the data storage device or hard drive may also monitor which tracks have been modified and keep a record of which tracks are different between any two Host Access Spaces (HASs) 600. Using this technique, only different tracks need to be transferred during either a backup or restore operation.

In one application, one or more embodiments of the present invention may be attached to a host device 200′ such as a family computer shared by various members of a family. A parent could set up the data storage device or hard drive 700 to include separate Host Access Spaces (HASs) for the parent and children. A child's Host Access Space (HAS) 600 may have a lesser suite of applications, an example of which would not include Internet access software or have printer drivers enabled. In such a representative application, a child could turn on the host device (e.g., computer) and play their computer games or do homework but not have access to Internet access software. Accordingly, the parent, for example, would not need to worry about the children surfing the Internet, printing out 1000 pages on the laser printer, or accidentally deleting the family bookkeeping files. Alternatively, if the parent had enabled Internet access for the children, the family documents stored in other Host Access Spaces (HASs) would be safe from any spyware the children might accidentally download.

In another application, one or more embodiments of the present invention may be attached to a host device 200′ such as a software development workstation. A data storage device or hard drive 700 could be attached to a host device 200′ (e.g., workstation) used by a single individual who, for example, tests software on a variety of operating systems. The user could configure the data storage device or hard drive to have five different Host Access Spaces (HASs) 600. The user could install a different operating system on each of the Host Access Spaces (HASs) 600 and using, for example, a switch 702 on the data storage device or hard drive 700, or by a special software program 704 running on the host device 200′, the user could boot the host device 200′ (e.g., workstation) with a different operating system each time a different Host Access Space (HAS) 600 was selected. In each case, the currently running operating system could not interfere in any way with the files stored in the Host Access Spaces (HASs) 600 of the other operating systems.

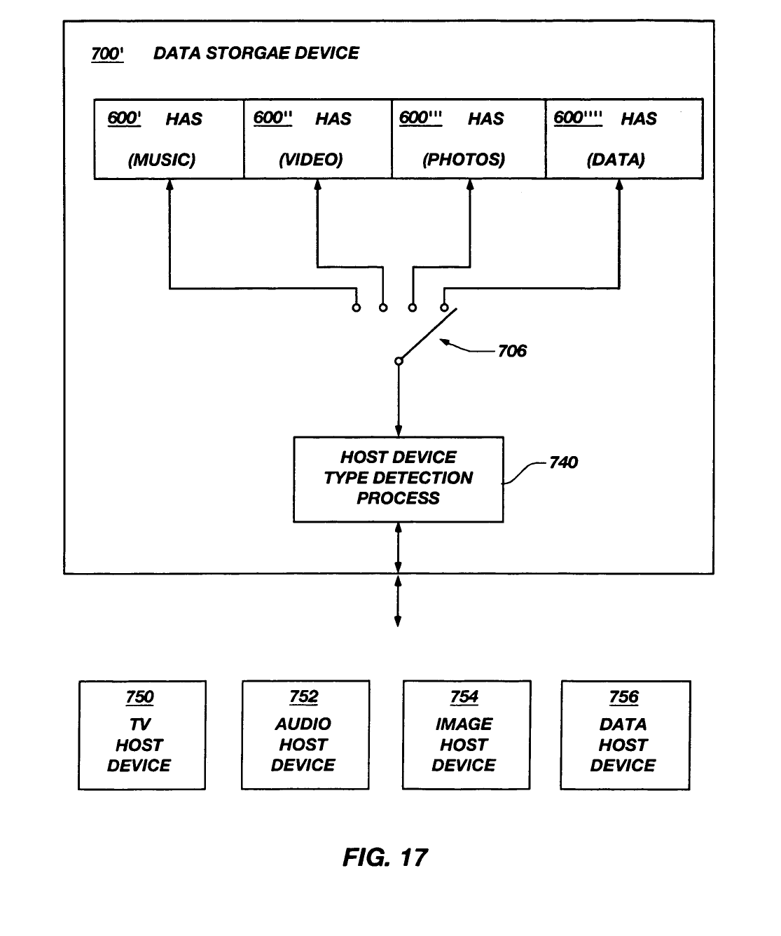

FIG. 17 illustrates dividing user space into data type specific Host Access Spaces (HASs), in accordance with another embodiment of the present invention. A data storage device or hard drive 700′ may be divided into a plurality of Host Access Spaces (HASs) 600′-600″″ with each Host Access Space (HAS) containing a specific data content that is accessible by a specific data type of host device. A data storage device or hard drive 700′ could be used by someone to attach to a number of different data type host devices. Representative dedicated type host devices may include a television host device 750, an audio player (e.g., MP3 player) host device 752, an image (e.g., camera, image player, video player) host device 754, and a data host device 756. Using this invention, the data storage device or hard drive 700′ could be configured to include Host Access Spaces (HASs) that contain specific types of data. For example, one Host Access Space (HAS) 600′ may contain music files while another Host Access Space (HAS) 600″ may contain video files. Other Host Access Spaces (HASs) may include Host Access Space 600′″ configured to include image or photo data and another Host Access Space (HAS) 600″″ to include other forms of data.

When a specific data type of host device 750-756 is coupled to data storage device or hard drive 700′, a host device type detection process 740 recognizes the specific data type device and selects the corresponding one of the Host Access Spaces (HASs) 600′-600″″ that corresponds to the detected specific type of data device. For example, when a user connects the data storage device or hard drive 700′ into an audio host device 752, the audio host device 752 sends the data storage device or hard drive 700′ an identifier (or the data storage device or hard drive otherwise identifies the host device) that matches the Host Access Space (HAS) 600′ containing music data.

Likewise, when a user connects the data storage device or hard drive 700′ to a data (e.g., computer) host device 756, the data host device 756 sends the data storage device or hard drive 700′ an identifier that matches the Host Access Space (HAS) 600″″ containing software or other computer data. Similarly, when a user connects the data storage device or hard drive 700′ to a video or television host device 750, the television host device 750 sends the data storage device or hard drive 700′ an identifier that matches the Host Access Space (HAS) 600″ containing video data. Also, when a user connects the data storage device or hard drive 700′ to an image host device 752, the image host device 752 sends the data storage device or hard drive 700′ an identifier that matches the Host Access Space (HAS) 600′″ containing photos or other image data. Alternatively, a unique identifier may be stored in each of the host devices and the data storage device or hard drive may recognize and match the unique identifier and select a specific corresponding Host Access Space (HAS). A default Host Access Space (HAS) may also be selected if a specific data type of host device is not identified. The present embodiment finds application in protecting types of data from corruption by malware or other viruses that could destroy or corrupt data if certain types of host devices are connected.

What is claimed is:

1. A data storage device for coupling to a host device, comprising:
a user space including a plurality of sectors for storing data therein;
a plurality of host access spaces each including a corresponding plurality of portions of the plurality of sectors wherein only one of the plurality of host access spaces is accessible at any one time to the host device; and
a switch for selecting each one of the plurality of host access spaces.

2. The data storage device of claim 1, wherein the user space is distributed over at least one platter having a plurality of surfaces for storing the data thereon.

3. The data storage device of claim 2, wherein each of the plurality of host access spaces respectively corresponds to each of the plurality of surfaces.

4. The data storage device of claim 2, wherein each of the plurality of host access spaces includes a plurality of surfaces.

5. The data storage device of claim 1, wherein at least one of the plurality of host access spaces is configured as a data backup host access space of another one of the plurality of host access spaces.

6. The data storage device of claim 5, wherein data from the another one of the plurality of host access spaces is sent internally to the data storage device to the data backup host access space.

7. The data storage device of claim 1, wherein the switch is actuated to designate one of the plurality of host access spaces according to one of a manually actuatable switch at the data storage device to specify one of the plurality of host access spaces, settable to one of the plurality of host access spaces by the host device, and actuatable in response to repetitive power cycling of the data storage device to select one of the plurality of host access spaces.

8. The data storage device of claim 1, wherein the switch is actuated to designate one of the plurality of host access spaces according to one of a type of the host device coupled thereto or a matched unique identifier of the host device.

9. A system, comprising:
a host device; and
a data storage device coupled to the host device, the data storage device including:
i. a user space including a plurality of sectors for storing data therein;
ii. a plurality of host access spaces each including a corresponding plurality of portions of the plurality of sectors wherein only one of the plurality of host access spaces is accessible at any one time to the host device; and
iii. a switch for selecting each one of the plurality of host access spaces.

10. The system of claim 9, wherein the user space is distributed over at least one platter having a plurality of surfaces for storing the data thereon.

11. The system of claim 10, wherein each of the plurality of host access spaces respectively corresponds to each of the plurality of surfaces.

12. The system of claim 10, wherein each of the plurality of host access spaces includes a plurality of surfaces.

13. The system of claim 9, wherein at least one of the plurality of host access spaces is configured as a data backup host access space of another one of the plurality of host access spaces.

14. The system of claim 13, wherein data from the another one of the plurality of host access spaces is sent internally to the data storage device to the data backup host access space.

15. The system of claim 9, wherein the switch is actuated to designate one of the plurality of host access spaces according to one of a manually actuatable switch at the data storage device to specify one of the plurality of host access spaces, settable to one of the plurality of host access spaces by the host device, and actuatable in response to repetitive power cycling of the data storage device to select one of the plurality of host access spaces.

16. The system of claim 9, wherein the switch is actuated to designate one of the plurality of host access spaces according to one of a type of the host device coupled thereto or a matched unique identifier of the host device.

17. A method for restricting access by a host device to only a portion of a data storage device, comprising:
dividing a user space including a plurality of sectors for storing data therein on the data storage device into a plurality of host access spaces;
selecting one of the plurality of host access spaces as an active host access space; and
restricting access by the host device to only the active host access space.

18. The method of claim 17, further comprising distributing the user space over at least one platter having a plurality of surfaces for storing the data thereon.

19. The method of claim 18, wherein each of the plurality of host access spaces respectively corresponds to each of the plurality of surfaces.

20. The method of claim 18, wherein each of the plurality of host access spaces includes a plurality of surfaces.

21. The method of claim 17, further comprising configuring at least one of the plurality of host access spaces as a data backup host access space of another one of the plurality of host access spaces.

22. The method of claim 21, further comprising transferring internally to the data storage device data from the another one of the plurality of host access spaces to the data storage device to the data backup host access space.

23. The method of claim 17, wherein the active host access space is selected by one of manually actuating a switch at the data storage device to specify the active host access space, the host device setting the active host access space, and cycling power to the data storage device to select the active host access space.

24. The method of claim 17, wherein the selecting the active host access space further comprises selecting the active host access space in response to one of a type of the host device coupled to the data storage device or a matched unique identifier of the host device.
